(19) United States
(12) Patent Application Publication
(10) Pub. No.: US 2004/0187370 A1
(43) Pub. Date: Sep. 30, 2004

(54) Container with identifier

(76) Inventor: Suzanne M. Buzby, Sewell, NJ (US)

Correspondence Address: Ms. Suzanne Buzby, 25 Meadow Court, Sewell, NJ, 08080, US

(21) Appl. No.: 10/397,330

(22) Filed: Mar. 26, 2003

(51) Int. Cl. G09F 3/00; G09F 3/16

(52) U.S. Cl. 40/324; 40/666

(57) ABSTRACT

A container includes an identifier portion capable of receiving an identifying mark for conveying information such as the possessor of the container, the contents of the container, a desired message, or a combination thereof. The container may be a drinking cup or a container for storing contents such as food and the like. The container may be rigid, such as a glass or a hard plastic, or flexible, such as a re-sealable flexible storage bag. The identifier portion may comprise text, graphics, raised lettering or symbols, color coding, aroma coding, or a combination thereof. The identifier portion may be integrally formed with the container or attached to a surface of the container. The identifying mark may be written on, drawn on, painted on, sprayed on, inserted into, extracted from, permanently formed on, the identifier portion; or a combination thereof.

### FIELD OF THE INVENTION

The present invention relates generally to identifiers, and more specifically to identifiers for containers.

### BACKGROUND

There are many situations, in which the need to identify the contents of a container, such as a drinking cup, a storage container, or the like, is desired. For example, it is quite common for a person to misplace a drinking cup (container) at a party. That person may place a drinking cup on a surface, such as a table, and leave the room. Upon reentering the room, the person may have difficulty determining which drinking cup is hers. This is particularly applicable to situations where several drinking cups are also on the table. Even more so if the drinking cups look similar, such as plastic party cups. Many scenarios tend to exacerbate this occurrence. One such scenario involves a person under the influence of alcohol (e.g., at an adult party), which may tend to cause that person to be more likely to be confused by similar looking cups. Another scenario is one in which children at a party, such as a birthday party, may be likely to take the wrong cup.

Another situation in which means for identifying the contents of a container is desired involves a person with a substance abuse problem fearing drinking from a cup containing alcohol or the like. In this situation, the person would want to be reasonably confident that the cup from which she is drinking does not contain the potentially dangerous substance.

Yet another situation involves a person with a disability, such as impaired vision. This person also would want to be reasonably confident that she has selected the proper container.

Similarly, it is not uncommon for persons to store items in storage containers (e.g., freezer containers, kitchen cupboard containers). After some time has passed, it may be difficult to remember what is stored in the container. This often requires the person to open the container to determine its contents. This could be a particular disadvantage in situations wherein several similar looking containers are implemented. For example, a person store may several different types of food in several freezer containers. After some period of time, when the person wants to retrieve a particular item, that person may have to open each container to determine its contents, until the desired item if found. Another example involves the situation wherein a person stores several different types of dry goods (e.g., protein powders, health food powders) in similar looking containers. In this situation, the items may look enough alike, that it may be difficult to distinguish them.

Therefore, a need exists for means for identifying contents of a container and identifying a possessor of a container.

### SUMMARY OF THE INVENTION

A container has an identifier portion for receiving an identifying mark for conveying information.

### BRIEF DESCRIPTION OF THE DRAWINGS

The features and advantages of the present invention will be best understood when considering the following description in conjunction with the accompanying drawings, of which:

FIG. 1 is an illustration of a container in the form of a cup having an identifier portion in accordance with an embodiment of the present invention;

FIG. 2A is an illustration of the identifier portion having an elastic portion in accordance with an embodiment of the present invention;

FIG. 2B is an illustration of the identifier portion having clips for coupling to the elastic portion in accordance with an embodiment of the present invention;

FIG. 3A is an illustration of the identifier portion having a resilient clip coupled to the container in accordance with an embodiment of the present invention;

FIG. 3B is an illustration of the identifier portion having a plurality of resilient clips coupled to a rectilinear container in accordance with an embodiment of the present invention;

FIG. 4 is an illustration of an identifier portion comprising a cavity defined by the container and an insertable portion in accordance with an embodiment of the present invention;

FIG. 5 is an illustration of an identifier portion comprising a cavity defined by the container configured to receive a business card, a photograph, or the like, in accordance with an embodiment of the present invention;

FIG. 6 is an illustration of an identifier portion comprising a cavity defined by the identifier portion coupled to a container by a resilient clip in accordance with an embodiment of the present invention;

FIG. 7 is an illustration of a container comprising a lid having an identifier portion on the lid in accordance with an embodiment of the present invention;

FIG. 8 is an illustration of a rectilinear shaped container comprising a lid having a plurality of identifier portions on the container in accordance with an embodiment of the present invention; and

FIG. 9 is an illustration of a flexible container comprising an identifier portion having a cavity defined by the container configured to receive an insertable portion in accordance with an embodiment of the present invention.

### DETAILED DESCRIPTION

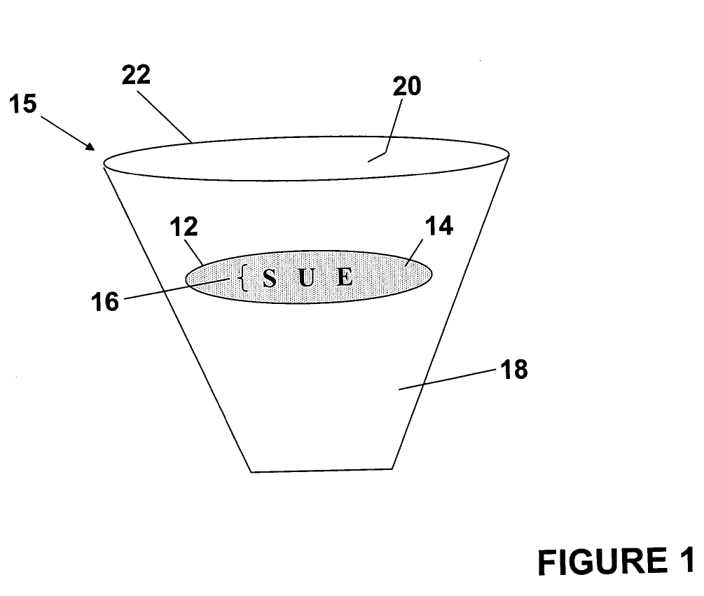

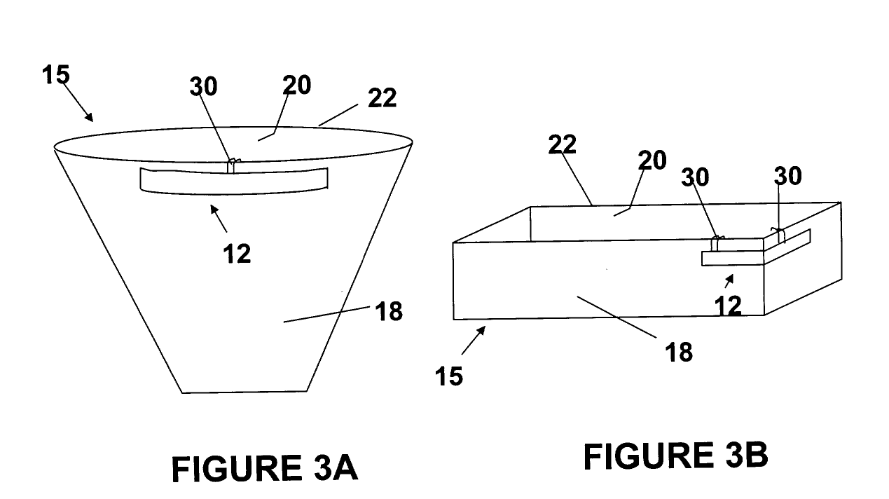

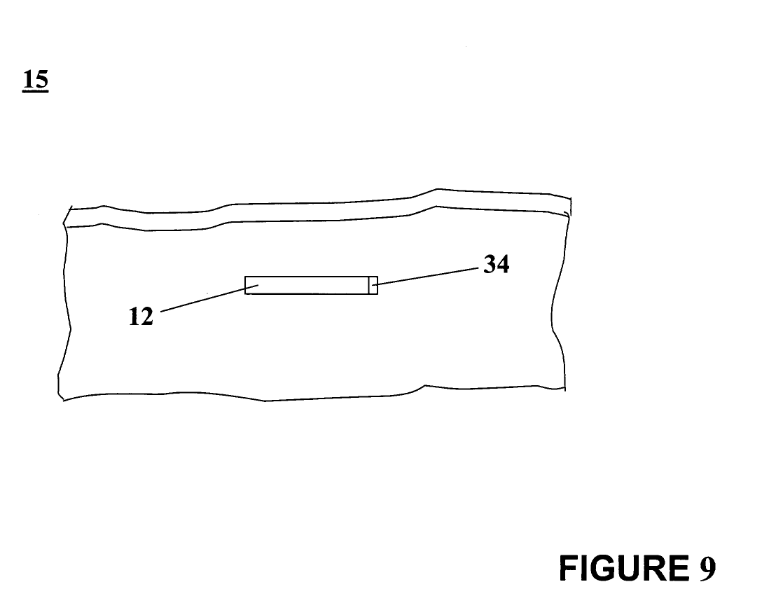

A container as described herein comprises an identifier portion capable of receiving an identifying mark for conveying information such as the possessor of the container, the contents of the container, a desired message, or a combination thereof. Various embodiments of the container are envisioned. The container may be a drinking cup (See FIG. 1 for example) or a container for storing contents such as food and the like (See FIG. 3B for example). The container may be rigid, such as a glass or a hard plastic, or flexible, such as a re-sealable flexible storage bag (See FIG. 9 for example). The identifier portion may comprise text, graphics, raised lettering or symbols, color coding, aroma coding, or a combination thereof. The identifier portion may be integrally formed with the container or attached to a surface of the container. The identifying mark may be written on the identifier portion, drawn on the identifier portion, painted on the identifier portion, sprayed on the identifier portion, inserted into the identifier portion, extracted from the identifier portion, or permanently formed on the identifier portion, for example.

An exemplary embodiment of a container in accordance with the present invention is in the form of a plastic disposable drinking cup used at parties. The identifier portion of the cup is an oval shaped area on the outer surface of the cup. The identifier portion has a textured surface allowing the identifying mark to be written on the textured surface with a writing utensil. Each possessor of a cup may write his or her name on a respective cup, thus mitigating doubt about the possessor and/or contents of the cup.

Referring now to FIG. 1, there is shown a container 15 in the form of a cup, such as a drinking cup, comprising an identifier portion 12 in accordance with an embodiment of the present invention. The container 15 comprises outer surface 18, inner surface 20, and edge 22. The identifier portion 12 may be in any appropriate shape, such as oval, rectangular, rectilinear, or polygonal, for example. The identifier portion 12 may comprise any portion of the surface area of the container 15. The identifier portion 12 comprises a surface 14, which allows marking of the surface 14 with an identifying mark 16. The surface 14 may be textured, color-coded, aroma-coded, or a combination thereof. The identifying mark 16 may convey various types of information, such as the possessor of the container 15 (e.g., Sue), the contents of the container 15 (e.g., lemonade), a message (e.g., “Happy Birthday”), or a combination thereof, for example. The identifying mark 16 may be formed by any appropriate means, such as a writing instrument (e.g., pencil, pen, crayon, marker), a painting instrument (e.g., brush, tube, finger-paint, spray-paint), permanently embedded on the identifier portion (e.g., molded into the container 15), or a combination thereof, for example. The identifying mark 16 may comprise text, graphics, shapes (e.g., symbols), color-coding, raised (or indented) lettering and/or symbols (e.g., Braille), or a combination thereof.

In another embodiment of the present invention, the identifier portion 12 and/or the container 15 comprise an identifying aroma. This aroma-coded embodiment is particularly advantageous for persons with impaired vision. It is envisioned that the aroma is releasable via a variety of mechanisms. For example, the aroma may be released by scratching or rubbing (e.g., scratch and sniff) the identifier portion 12 or the surface 18, by deforming the container 15 (e.g., squeezing the cup slightly), or the aroma may be released by removing a cover (e.g., thin plastic material) from the aroma releasing portion of the container 15. In other embodiments, the aroma is inherently released without an overt action from a user. In yet another embodiment, the identifier portion 12 and/or the outer surface 18 of the container 15 may comprise an absorbent material, allowing one to apply an aroma releasing agent, such as cologne for example. Thus, one may apply an aroma releasing material, wherein the specific released aroma allows identification of the container 15. The identifier portion 12 may comprise a predetermined aroma. For example, containers 15 may be available in a variety of predetermined aromas. The identifier portion 12 may also be color coded to coincide with the aroma-coding (e.g., purple with grape, red with cherry, black with licorice, yellow with banana). Furthermore, the identifying marks 16 of the identifier portion 12 may be textured and/or comprise raised/indented markings, such as Braille.

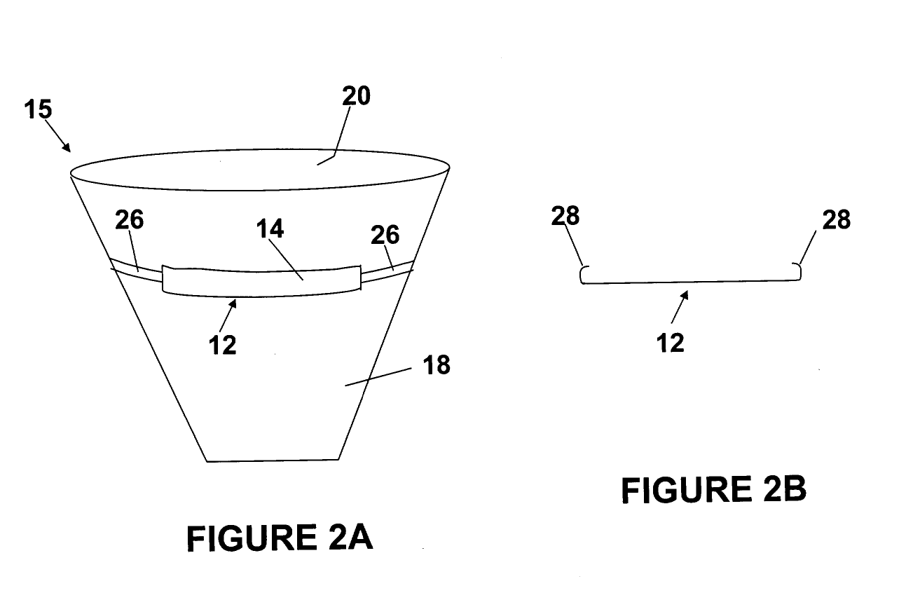

In various embodiments of the present invention, the identifying mark 16 is removable from the identifier portion 12 attached thereto. Removing the identifying mark 16 allows for remarking. The identifying mark 16 may be removed by any appropriate means, such as wiping the identifying mark 16 off with a cloth, removing the identifying mark 16 with the aid of a solution (e.g., cleaning fluid), by washing the container 15 (e.g., place in a dishwasher), or a combination thereof. Furthermore, the identifier portion 12 may be removable from the container 15. Removable identifier portions 12 may be reusable or disposable. As described in more detail herein, examples of removable identifier portion 12 include an identifier portion 12, which is attached to the container 15 by an elastic portion 26 (See FIG. 2A); an identifier portion 12, which is resiliently clipped to the container 15 (See FIGS. 3A and 3B); an identifier portion 12, which is attached to the container 15 by a static electrical charge developed between the surface 18 of the container 15 and the identifier portion 12.

FIG. 2A illustrates of an embodiment of the identifier portion 12 having an elastic portion 26. The elastic portion 26 facilities attachment of the identifier portion 12 to the outer surface 18 of the container 15. The elastic portion 26 may comprise any appropriated material having elastic properties, such as rubber, plastic, or a combination thereof, for example. To attach the identifier portion 12 to the outer surface 18, the elastic portion 26 is stretched around the outer surface 18 and positioned accordingly. To detach the identifier portion 12 from the outer surface 18, the elastic portion 26 is stretched and the identifier portion 12 is removed. In one embodiment, the identifier portion 12 is permanently attached to the elastic portion 26. In this embodiment, the identifier portion 12 and the elastic portion 26 are capable of being removed, and disposed/reused as a single unit. In another embodiment, the elastic portion 26 is removable from the identifier portion 12 as described below with respect to FIG. 2B.

FIG. 2B is a side view of the identifier portion 12 comprising fasteners 28, in the form of clips, for attaching the elastic portion 26 to the identifier portion 12. For example, the elastic portion 26 may be a rubber band, which is attached to the identifier portion 12 by the clips 28. The identifier portion 12 may be attached to the container 15 with either of the clips 28 positioned directly adjacent the outer surface 18 (clips 28 facing inward toward the container 15), or the identifier portion 12 may be attached to the container 15 with either of the clips 28 positioned away from the outer surface 18. The embodiment of the identifier portion 12 comprising clips 28 for attaching and detaching elastic portion 26 thereto allows various size elastic portions 26 to be used to accommodate various size and shape containers 15, and also allows the identifier portion 12 and the elastic portion 26 to be disposed/reused individually and independently of each other. Although shown as clips, fasteners 28 may be in the form of any appropriate fastening means, such as snaps, strapped fasteners, buckles, VELCRO®, pressure sensitive adhesive, a single clip, or a combination thereof, for example.

Although not explicitly shown in FIG. 2A, it is envisioned that in another embodiment of the invention, the portion 26 and the portion 12 are insertable into the inner portion of the container 15 adjacent the inner surface 20. In this embodiment, the portion 26 is rigid enough, so as not to significantly deform when placed inside the container 15. Once the combination of the portions 26 and 12 are positioned adjacent the inner surface 20, such that the circumference of the inner portion 20 is approximately equal to the circumference of the combination of the portions 26 and 12, the combination of portions 26 and 12 will remain relatively fixed in that position with respect to the inner surface 20.

FIG. 3A and FIG. 3B show embodiments of the identifier portion 12 having at least one fastener in the form of a resilient clip 30. The resilient clip 30 facilities attachment of the identifier portion 12 to the edge 22 of the container 15. To attach the identifier portion 12 to the edge 22, the resilient clip 30 is pushed onto the edge 22. To detach the identifier portion 12 from the edge 22, it is simply pulled off of the edge 22. The identifier portion 12 may comprise more than one resilient clip 30. Furthermore, the identifier portion 12 may be conformable (e.g., flexible), allowing the identifier portion 12 to be conformably attached to the container 15. A conformable identifier portion 12 is depicted in FIG. 3B. A conformable identifier portion 12 having a plurality of resilient clips 30 allow the identifier portion 12 to be attached to a variety of size and shape containers. The identifier portion 12, utilizing the clip(s) 30, is attachable adjacent the outer surface 18, the inner surface 20, or both. Attaching the identifier portion 12 adjacent the inner surface 20 of the container 15 utilizing the clips 30, allows the contains 15 to be stored without concern for perturbations protruding from the outer surface 18. This is advantageous in situations in which the containers 15 have lids, and are to be stacked in a relatively confined area. Identification is further facilitated if the container 15 is transparent or at least translucent, such that the identifying mark 16 is observable through the container wall.

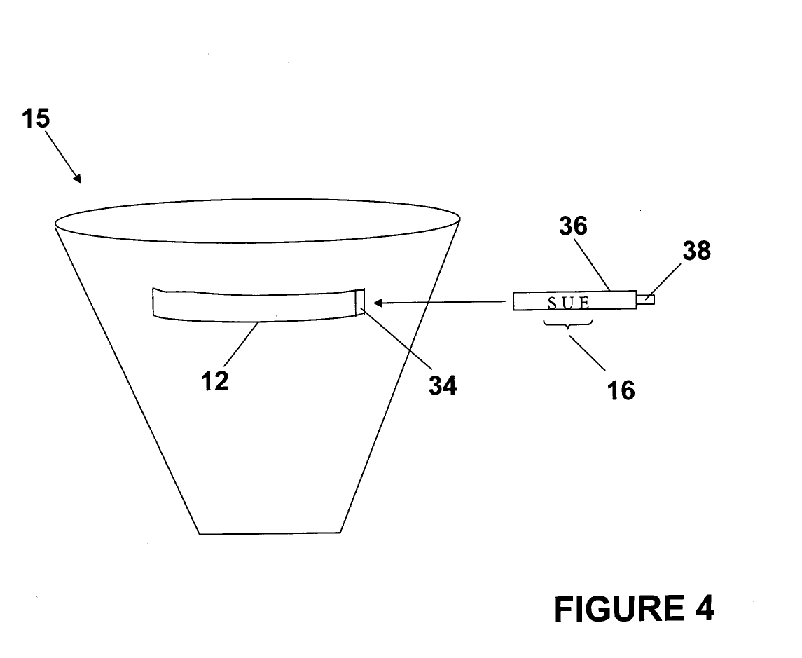

FIG. 4 is an illustration of an identifier portion 12 comprising a cavity 34 defined by the container 15 and an insertable portion 36 comprising the identifying mark 16, in accordance with an embodiment of the present invention. The insertable portion 36 is inserted into the cavity 34 defined by the identifier portion 12, thus allowing identification of the container 15. The insertable portion 36 is removable. In one embodiment, the insertable portion 36 is removed from the identifier portion 12 utilizing the tab 38. The insertable portion 36 includes the identifying mark 16. This identifying mark 16 may be in the form of the various embodiments as described above, and also may be applied in accordance with the various embodiments described above. For example, the identifying mark 16 may comprise text, graphics, shapes (e.g., symbols), color-coding, aroma-coding, or a combination thereof. The identifying mark 16 may be written, drawn, painted, sprayed, and/or permanently formed on the insertable portion 36, for example. The identifier portion 12 is preferably transparent and/or translucent allowing the identifying mark 16 to be observed when inserted into the identifier portion 12. The shape and size of the insertable portion 36 and respective identifier portion 12, as shown in FIG. 4 are exemplary, and not to be limited thereto. Other shapes and sizes are envisioned. Also, the position of the open end of the cavity 34 as depicted in FIG. 4 is exemplary. For example, the open end of the cavity 34 may be positioned on the left, right, top, and/or bottom of the identifier portion 12.

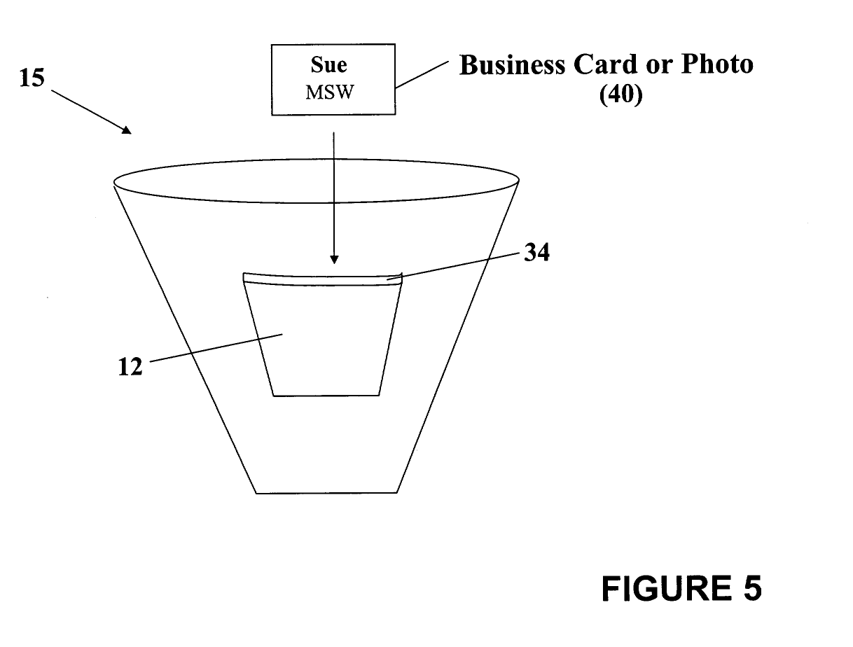

FIG. 5 is an illustration of an identifier portion 12 comprising a cavity 34 defined by the container 15 configured to receive an insertable portion in the form of a business card and/or photograph 40 in accordance with an embodiment of the present invention. The embodiment depicted in FIG. 5 is similar to the embodiment depicted in FIG. 4, where the insertable portion is in the form of a business card 40. The insertable portion may be in any appropriate form, such as a photograph, for example.

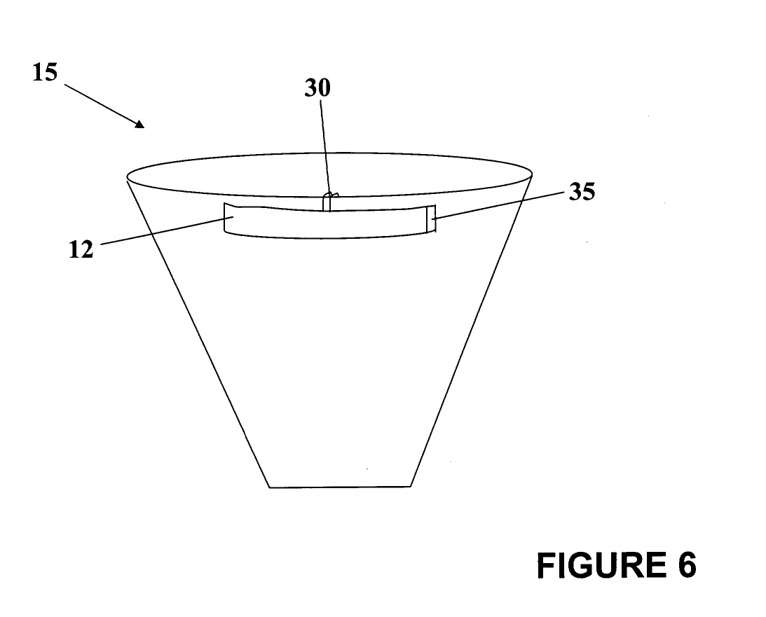

FIG. 6 is an illustration of an identifier portion 12 comprising a cavity 35 defined by the identifier portion 12 coupled to the container 15 by a resilient clip 30 in accordance with an embodiment of the present invention. The cavity 35 is defined by the inner and outer surfaces of the identifier portion 12 (inner and outer portions of identifier portions not specifically labeled in FIG. 6). The embodiment depicted in FIG. 6 is similar to the embodiment depicted in FIG. 4, where the identifier portion 12 is attached to the container 15 by clips 30, and the cavity 34 is defined by the identifier portion 12. Furthermore, the clip 30 may be in accordance with any combination of the embodiments described above.

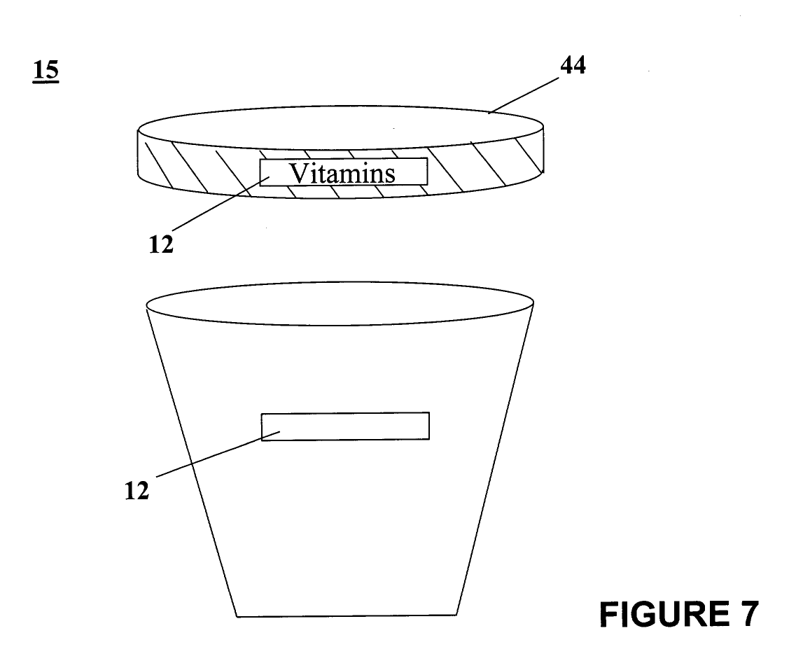

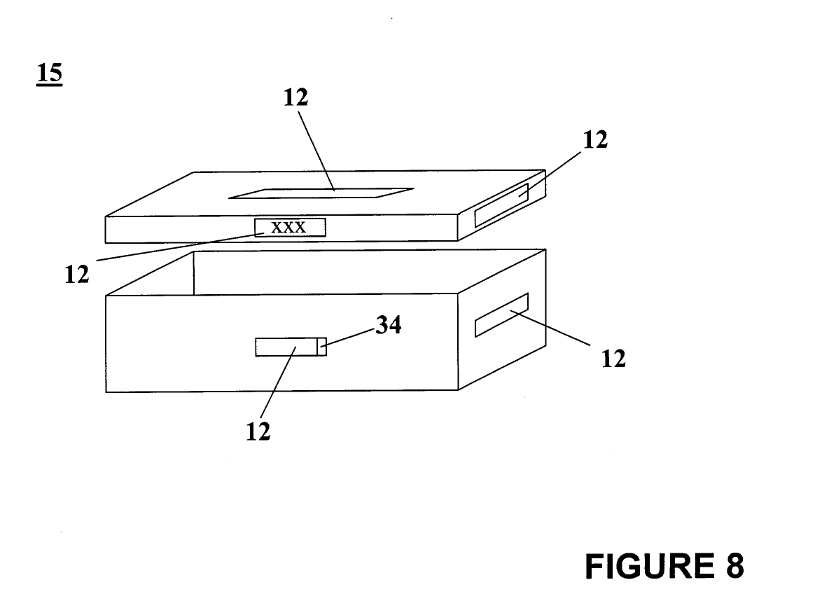

FIG. 7, FIG. 8, and FIG. 9 depict further exemplary embodiments of the present invention. FIG. 7 is an illustration of a container 15 comprising a lid 44 having an identifier portion 12 on the lid 44 in accordance with an embodiment of the present invention. FIG. 8 is an illustration of a rectilinear container 15 comprising a lid 44 having a plurality of identifier portions 12 on the container 15 in accordance with an embodiment of the present invention. The location, position, size, and number of identifier portions 12 are optional. This applies to the embodiments shown in FIG. 7 and FIG. 8, as well as the other appropriate embodiments described herein. For example, only a lid may comprise an identifier portion 12, only the base portion of the container 15 may comprise an identifier portion 12, or both may comprise an identifier portion 12. Each portion (e.g., lid or content holding portion) of the container 15 may comprise a single identifier portion 12 or multiple identifier portions 12. FIG. 9 is an illustration of a flexible container 15 comprising an identifier portion 12 having a cavity 34 defined by the container 15 configured to receive an insertable portion in accordance with an embodiment of the present invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention. Also, various combinations of the herein described embodiments are envisioned, even if not explicitly depicted in text and/or the figures. For example, the container 15 may be cylindrical shaped, rectilinear, rigid, flexible, or a combination thereof. The identifier portions may comprise various combinations of color-coding and aroma-coding. The container 15 may comprise a lid 44, or may not comprise a lid 44. The identifying marks may include combinations of text, graphics, color, aroma, and/or texture (e.g., Braille). The container 15 may comprise any number and combination of identifier portions 12. The identifier portion 12 may be positioned adjacent the inner surface 20 and/or adjacent the outer surface 18 of the container 15.

What is claimed is:

1. A container comprising an identifier portion for receiving an identifying mark for conveying information.

2. A container in accordance with claim 1, wherein said identifier portion is detachable and reattachable.

3. A container in accordance with claim 1, said identifier portion further comprising:
at least one resilient clip for attaching said identifier portion to said container.

4. A container in accordance with claim 1, wherein said container is one of a cup, a rigid storage container, and a flexible storage container.

5. A container in accordance with claim 1, said identifier portion further comprising:
an elastic portion for attaching said identifier portion to said container.

6. A container in accordance with claim 1, further comprising:
a cavity defined by an outer surface of said container and an inner surface of said container, wherein:
said cavity comprises at least one open edge for receiving said identifier portion,
said identifier portion is attached to said container via insertion of said identifier portion into said cavity; and
said identifier portion is detached from said container via extraction of said identifier portion from said cavity.

7. A container in accordance with claim 1, said identifier portion further comprising:
a cavity defined by an outer surface of said identifier portion and an inner surface of said identifier portion, wherein:
said cavity comprises at least one open edge for receiving said identifying mark,
said identifier portions receives said identifying mark by inserting said identifying mark into said cavity; and
said identifying mark is extractable from said cavity.

8. A container in accordance with claim 1, further comprising a lid comprising said identifier portion.

9. A container in accordance with claim 1, wherein said identifier portion is integrally formed with said container.

10. A container in accordance with claim 1, wherein said identifier portion is adhesively attached to said container.

11. A container in accordance with claim 1, wherein information is conveyed via at least one of color, aroma, texture, shape, graphics, text, indented symbols, and raised symbols.

12. A container in accordance with claim 1, wherein said identifier portion comprises a textured surface for receiving said identifying mark.

13. A container in accordance with claim 1, wherein information is conveying pertaining to at least one of a contents of said container, a possessor of said container, and a message.

14. A container in accordance with claim 1, wherein said identifier portion is attached to an edge of said container.

15. A container in accordance with claim 1, wherein said identifier portion is positioned adjacent at least one of an inner surface of said container and an outer surface of said container.

16. A container in accordance with claim 1, wherein said identifier portion is attached to a perimeter of said container.
